(19) United States
(12) Patent Application Publication
(10) Pub. No.: US 2024/0060513 A1
(43) Pub. Date: Feb. 22, 2024

(54) SILENCING DEVICE AND REFRIGERATOR

(71) Applicants: SHENYANG HAIER REFRIGERATOR CO., LTD., Shenyang City, Liaoning Province (CN); QINGDAO HAIER REFRIGERATOR CO., LTD., Qingdao City, Shandong Province (CN); HAIER SMART HOME CO., LTD., Qingdao City, Shandong Province (CN)

(72) Inventors: YANBIN WAN, Qingdao City, Shandong Province (CN); JIANQUAN CHEN, Qingdao City, Shandong Province (CN); WENCHUN WANG, Qingdao City, Shandong Province (CN); MENGCHENG LI, Qingdao City, Shandong Province (CN); GANG MA, Qingdao City, Shandong Province (CN); XINGPENG SUN, Qingdao City, Shandong Province (CN); LISHENG JI, Qingdao City, Shandong Province (CN)

(21) Appl. No.: 18/269,567

(22) PCT Filed: Dec. 27, 2021
(86) PCT No.: PCT/CN2021/141679

§ 371 Date: Jun. 25, 2023

(30) Foreign Application Priority Data
Dec. 25, 2020 (CN) 202023198929.X

(51) Int. Cl. F04D 29/66; F25D 23/00; F04D 19/00

(52) U.S. Cl. CPC F04D 29/665; F25D 23/006; F04D 19/002; F25D 2201/30

(57) ABSTRACT

Disclosed are a silencing device and a refrigerator; the silencing device includes a silencing body, the silencing body includes a hole wall enclosing a through hole and a silencing cavity formed inside the silencing body, and an opening communicated with the silencing cavity is provided on a surface of the hole wall. When the noise in the compressor compartment of the refrigerator passes through the through hole of the silencing device, the sound is transmitted into the silencing cavity through the opening. This achieves a good noise reduction effect while guaranteeing the normal operation of the refrigerator.

### TECHNICAL FIELD

The present utility model relates to a silencing device, and in particular, to a refrigerator with the silencing device.

### BACKGROUND

A refrigerator may generate noises during operation, a main source of the noises is a compressor in a compressor compartment, vibrations of the compressor are radiated out through the compressor compartment, and during operation, the compressor may produce heat while generating continuous noises, and therefore, heat dissipation is required to be performed on the compressor to guarantee normal work thereof. Therefore, a channel of the compressor compartment communicated with the outside is necessary, and the noise generated by the compressor is also transmitted to the outside through the channel, such that the noise around the refrigerator is difficult to suppress, thus influencing the user experiences of a user.

### SUMMARY

To solve the problem that the noises of a refrigerator in the prior art are difficult to suppress, an object of the present utility model is to provide a silencing device and a refrigerator having the same.

To achieve the above object of the utility model, an embodiment of the present utility model provides a silencing device, including a silencing body, wherein a through hole is formed in the silencing body, the silencing body includes a hole wall enclosing the through hole and a silencing cavity formed in the silencing body, and an opening, which communicates with the silencing cavity, is provided on the surface of the hole wall.

As a further improvement of the present utility model, a plurality of openings are arranged along a circumference of the surface of the hole wall, and volumes of the silencing cavities in at least two openings are different.

As a further improvement of the present utility model, the hole wall includes a plurality of sidewalls, and each sidewall is provided with multiple openings with different areas.

As a further improvement of the present utility model, a length direction of the openings on the plurality of sidewalls is arranged along an in-out direction of the through hole, and a width direction of the openings on the plurality of sidewalls is arranged in the in-out direction of the through hole.

As a further improvement of the present utility model, the silencing cavity is provided in a labyrinth shape.

To achieve the above object of the utility model, an embodiment of the present utility model provides a refrigerator, including a compressor compartment, wherein the silencing device as above is provided in the compressor compartment, and the compressor compartment is communicated with the outside through the through hole.

As a further improvement of the present utility model, the refrigerator includes a housing and a cavity enclosed by the housing, wherein the compressor compartment further includes a vent formed in the housing, and the through hole is provided oppositely to the vent.

As a further improvement of the present utility model, the housing includes sidewalls arranged on two sides of the cavity, the vent includes an air inlet formed in the sidewall on one side and an air outlet formed on the other sidewall, and the silencing body abuts against the sidewall.

As a further improvement of the present utility model, the silencing body is provided inside the cavity, the air inlet and the through hole opposite thereto have the same shape and are overlapped, and/or the air outlet and the through hole opposite thereto have the same shape and are overlapped.

As a further improvement of the present utility model, a fan is further included to be provided in the compressor compartment, wherein an air inlet direction of the fan faces the air inlet, and an air outlet direction of the fan faces the air outlet.

To achieve the above object of the utility model, an embodiment of the present utility model provides a refrigerator, including a compressor compartment, wherein a fan is provided in the compressor compartment, the silencing device as above is provided in the compressor compartment, the silencing device encloses a vent, and an air inlet and/or an air outlet of the fan are/is communicated with the vent.

As a further improvement of the present utility model, the silencing device forms a fan bracket, and the fan is fixedly mounted in the fan bracket.

As a further improvement of the present utility model, the fan is configured as a cross-flow fan, an air outlet of the cross-flow fan faces the outside, and the silencing device is provided at the air outlet.

Compared with the prior art, the present utility model has the following beneficial effects: when the noise in the compressor compartment of the refrigerator passes through the through hole of the silencing device, the sound is transmitted into the silencing cavity through the opening. This prolongs the propagation path of the sound, reduces its energy, and decreases the continuously emitted noise. As a result, the noise generated by the refrigerator is reduced, while the normal venting and heat dissipation in the compressor compartment remain unaffected. This achieves a good noise reduction effect while guaranteeing the normal operation of the refrigerator.

### BRIEF DESCRIPTION OF THE DRAWINGS

FIG. 1 is a schematic structural diagram of a compressor compartment in a first embodiment of the present utility model;

FIG. 2 is a schematic structural diagram of a silencing device according to the first embodiment of the present utility model;

FIG. 3 is a sectional view of the silencing device according to the first embodiment of the present utility model;

FIG. 4 is a schematic structural diagram of a compressor compartment in another embodiment of the present utility model;

FIG. 5 is a schematic structural diagram of a silencing device according to a second embodiment of the present utility model;

FIG. 6 is a sectional view of the silencing device according to the second embodiment of the present utility model;

FIG. 7 is a sectional view of a silencing device according to a third embodiment of the present utility model;

FIG. 8 is a schematic structural diagram of a compressor compartment in a fourth embodiment of the present utility model;

FIG. 9 is a schematic structural diagram of a compressor compartment in a fifth embodiment of the present utility model; and

FIG. 10 is a sectional view of the compressor compartment in the fifth embodiment of the present utility model.

In the drawings, 1. silencing device; 11. silencing body; 12. through hole; 13. hole wall; 14. silencing cavity; 15. opening; 2. compressor compartment; 20. cavity; 21. housing; 22. vent; 3. compressor; 4. fan.

### DETAILED DESCRIPTION

Hereinafter, the present utility model will be described in detail in conjunction with specific embodiments shown in the accompanying drawings. However, these embodiments have no limitations on the present utility model, and any transformations of structure, method, or function made by persons skilled in the art according to these embodiments fall within the protection scope of the present utility model.

It should be understood that the terms expressive of spatial relative positions, such as “upper”, “above”, “lower”, “below”, or the like herein are used to describe the relationship of a unit or feature relative to another unit or feature in the drawings, for the purpose of illustration and description. Terms expressive of the spatial relative positions are intended to include different orientations of the device in use or operation other than the orientations shown in the drawings.

An embodiment of the present utility model provides a silencing device 1 and a refrigerator, and by providing the silencing device 1 in a compressor compartment 2 of the refrigerator, noises sent out from the refrigerator are reduced to protect the environment around the refrigerator.

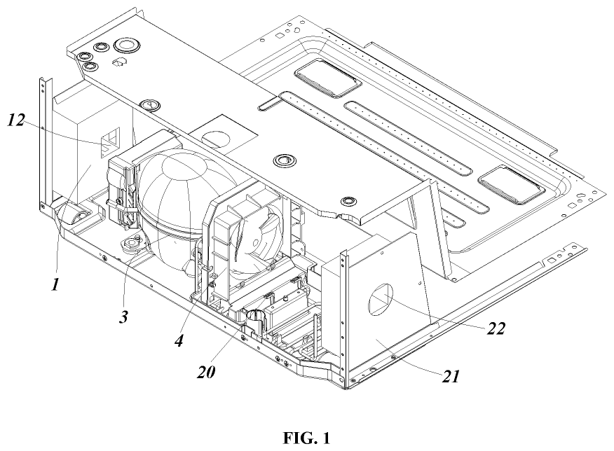

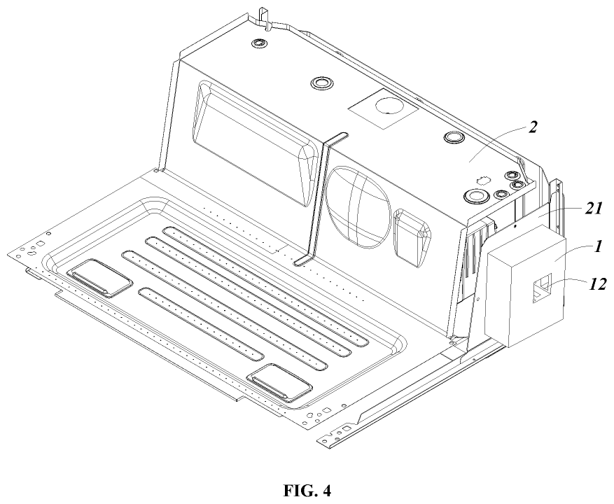

The refrigerator according to the embodiment includes the compressor compartment 2, as shown in FIG. 1 or 4; the silencing device 1 is provided in the compressor compartment 2, the compressor compartment 2 is communicated with the outside through a through hole 12, the compressor compartment 2 includes a housing 21 and a cavity 20 enclosed by the housing 21, and the compressor compartment 2 further includes a vent 22 formed in the housing 21 and configured for ventilation and heat dissipation.

To clearly express the positions and directions described in the present embodiment, in the present embodiment, the directly facing direction of a refrigerator door is defined to be front, the opposite direction is defined to be rear, the refrigerator is vertically placed on the ground, the direction of gravity is defined to be down, the opposite direction is defined to be up, and in front of the refrigerator, the two sides of the refrigerator serve as the left side and the right side of the refrigerator respectively, the compressor compartment 2 in the present embodiment is provided at the lower rear of the refrigerator, the vents 22 communicated with the outside are provided on the left side and the right side of the compressor compartment 2, and the left side and the right side are opposite; that is, when viewed from the right rear of the compressor compartment 2, the left side and the right side can be interchanged.

### First Embodiment

Specifically, as shown in FIGS. 1 to 7, the silencing device 1 in the present embodiment comprises a silencing body 11. The silencing body 11 has a through hole 12, and it also includes a hole wall 13 that encloses the through hole 12, as well as a silencing cavity 14 formed inside the silencing body 11. Additionally, there is an opening 15 on the surface of the hole wall 13 that communicates with the silencing cavity 14.

A sound passes through the through hole 12 when passing through the silencing device 1, and by providing the opening 15 on the hole wall 13 of the through hole 12, at least part of the sound passes through the opening 15 and then enters the silencing cavity 14 in the opening, the silencing cavity 14 has a certain depth, and the sound enters the opening 15 and then is propagated inside the silencing cavity 14, such that a propagation path of the sound during passing through the through hole 12 is prolonged, and a noise reduction effect is achieved by providing the acoustic metamaterial.

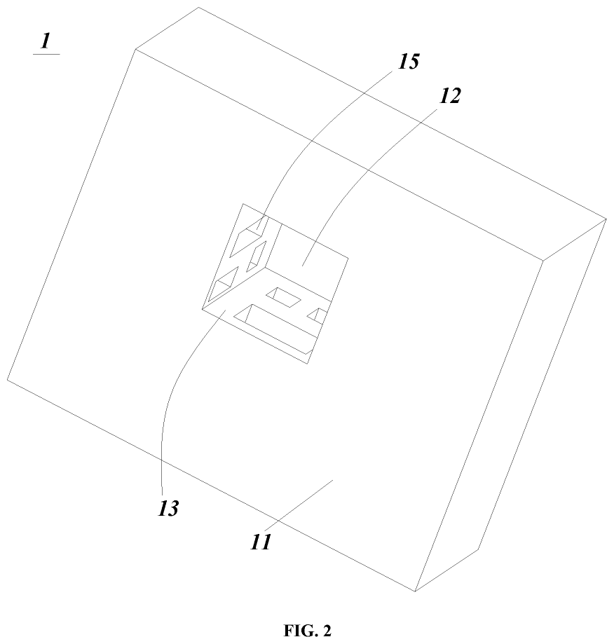

Further, a plurality of openings 15 are provided along a circumference of the surface of the hole wall 13, as shown in FIG. 2, and volumes of the silencing cavities 14 inside at least two openings 15 are different. The volume of the silencing cavity 14 can determine a frequency range of the sound capable of being eliminated by the silencing cavity 14; that is, different silencing cavities 14 have different silencing frequency ranges, and therefore, the sound can enter different openings 15 by adjusting the volumes of different silencing cavities 14, so as to eliminate the noises with different frequencies, such that the silencing device 1 has wider silencing frequencies.

The hole wall 13 includes a plurality of sidewalls, each sidewall is provided with a plurality of openings 15 with different areas, and under the condition that the sizes of the openings 15 are different, transmission directions and paths of sound waves entering different openings 15 after entering the openings 15 are changed, so as to realize noise reduction of the sounds with different wavelengths transmitted to various directions, noise reduction of the sounds with different frequency wavelengths, and noise reduction of the sound with a wider frequency after the sound passes through the plurality of different openings 15.

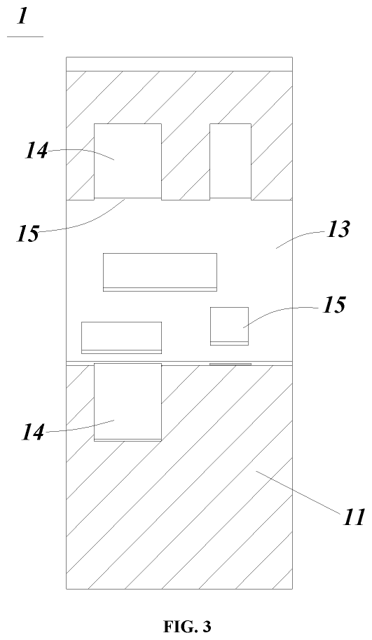

The opening 15 can be set to be rectangular, a length direction of the openings 15 on the plurality of sidewalls is arranged along an in-out direction of the through hole 12, and a width direction of the openings 15 on the plurality of sidewalls is arranged in the in-out direction of the through hole 12, as shown in FIG. 3, such that the waves in different directions are accommodated and absorbed transversely and vertically, thus further improving the noise reduction effect.

Further, the vent 22 on the compressor compartment 2 is provided oppositely to the through hole 12 of the silencing device 1, air flow passing through the vent 22 also can all pass through the through hole 12, the housing 21 of the compressor compartment 2 includes sidewalls arranged on two sides of the cavity 20, the vent 22 includes an air inlet formed in the sidewall on one side and an air outlet formed on the other sidewall, and the silencing body 11 abuts against the sidewall, such that the air flow entering and exiting flow the compressor compartment 2 all can pass through the silencing device 1, thereby guaranteeing noise reduction at an air inlet position and an air outlet position; other positions of the compressor compartment 22 are not communicated with the outside; that is, the compressor compartment 2 is communicated with the outside only through the vent 22, the sound may pass through the through hole 12 when passing through the vent 22, and then enters the silencing cavity 14 for noise reduction, and all the air flow entering and exiting from the compressor compartment 2 can be subjected to noise reduction.

Still further, the silencing body 11 is provided inside the cavity 20, as shown in FIG. 1; with such an arrangement, the exterior of the compressor compartment 2 may be filled with a foaming material and provided with an outer case as in an existing refrigerator; certainly, when the interior space of the compressor compartment 2 is limited and provision of the silencing body 11 in the compressor compartment is difficult, the silencing body may be provided outside the compressor compartment 2, as shown in the drawing; the air inlet and the through hole 12 opposite thereto have the same shape and are overlapped, and/or the air outlet and the through hole 12 opposite thereto have the same shape and are overlapped. In both air inlet and air outlet directions, the through hole 12 can be overlapped with the vent 22 to maximize ventilation.

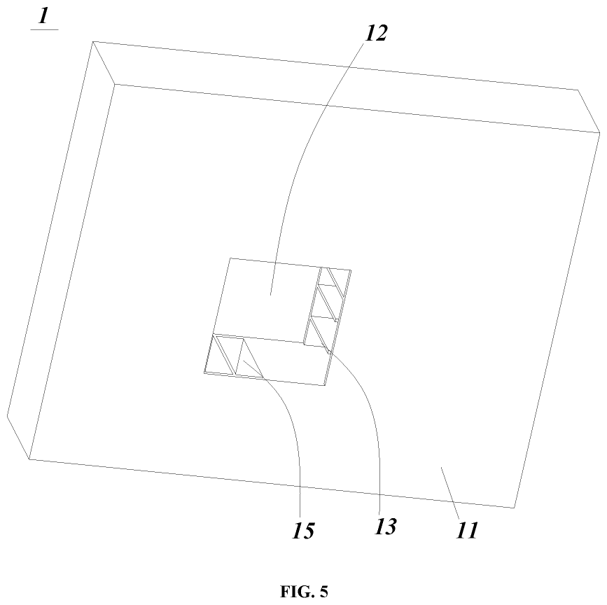

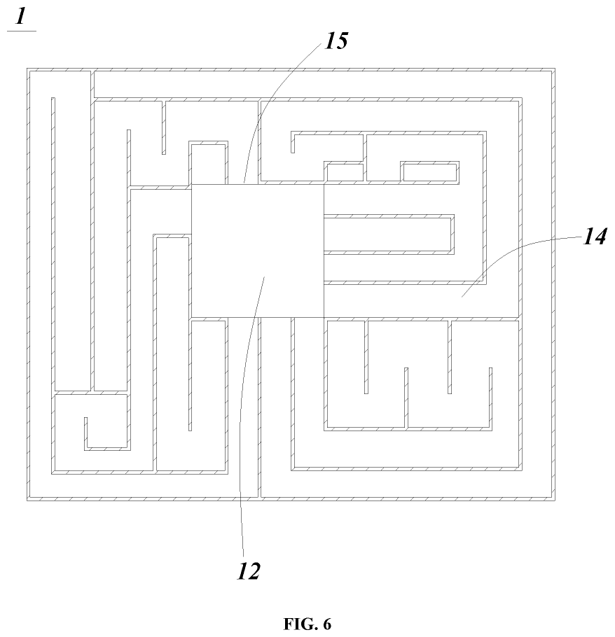

In a second embodiment, the silencing cavity 14 is provided in a labyrinth shape, as shown in FIGS. 5 to 6, such that the sound is further propagated to the interior after entering the silencing cavity 14, a large part of the sound cannot be reflected out, and therefore, the sound cannot leave the silencing device 1 to be emitted to the outside after entering the silencing cavity 14, thus further improving a silencing effect thereof.

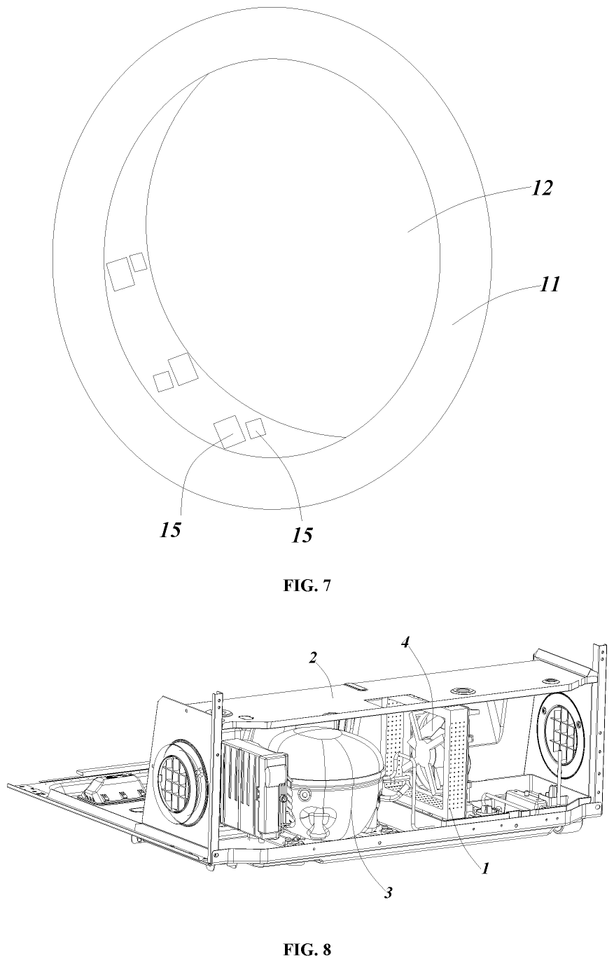

In a third embodiment, a circular hole is formed at the vent 22, and the silencing body 11 is also set to be circular and embedded on a circumference of an inner side of the vent 22, as shown in FIG. 7, such that the silencing body does not occupy a space inside or outside the compressor compartment 2; a circumferential surface of an outer side of the silencing body 11 abuts against the vent 22, and therefore, the airflow passing through the vent 22 passes through the through hole 12; a size of the vent 22 is designed to be greater, and after the silencing body 11 is mounted at the vent 22, an aperture of the through hole 12 is an aperture of the vent 22 when the silencing device 1 is not provided.

Furthermore, it includes a fan 4 positioned within the compressor compartment 2. The fan 4 is oriented with its air inlet facing the air inlet, while its air outlet faces the air outlet. The fan 4 forcing the airflow within the compressor compartment 2 to circulate, blowing air from the air inlet towards the air outlet.

In a fourth embodiment, a fan 4 is provided in the compressor compartment 2, the fan 4 may be configured as an axial flow fan, the silencing device 1 is provided in the compressor compartment 2, the silencing device 1 encloses the vent 22, and the air inlet and/or the air outlet of the fan 4 are/is communicated with the vent 22.

Specifically, as shown in FIG. 8, the silencing device 1 forms a structure of a fan bracket, a square frame is enclosed, the silencing device 1 forms a frame structure to support the fan 4, and the fan 4 is fixedly mounted in the fan bracket, such that when the fan guides the air flow to flow through the vent 22, the air flow enters the silencing cavity 14 of the silencing device 1, and the silencing device 1 achieves a noise reduction effect on all the air flow passing through the fan 4, thereby reducing noises of the fan 4.

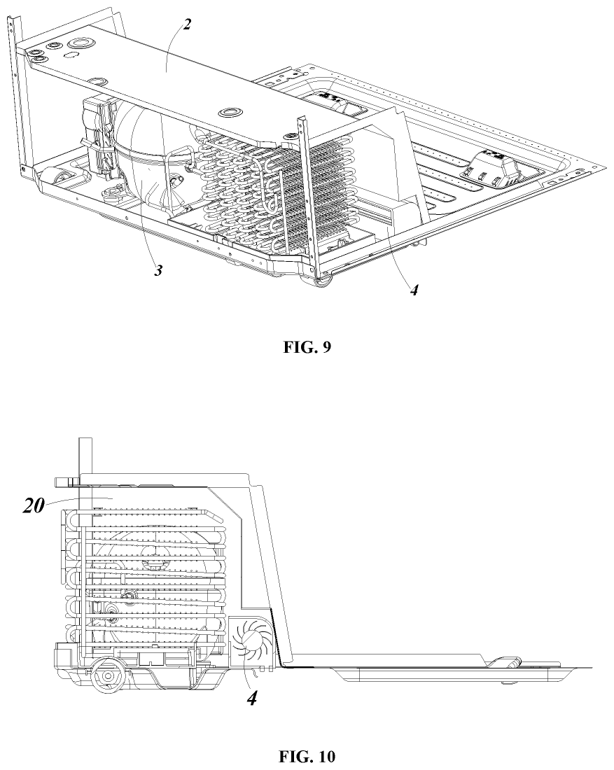

In addition, in a fifth embodiment, as shown in FIGS. 9 to 10, the fan 4 is configured as a cross-flow fan, an air outlet of the cross-flow fan faces the outside, and the silencing device 1 is provided at the air outlet, such that the airflow blown to the outside by the fan is all subjected to noise reduction by the silencing device 1, thus reducing the noise emitted from the compressor compartment 2; the air outlet of the cross-flow fan is in a strip shape, and the silencing device 1 is also set to be in two strip shapes oppositely and symmetrically arranged on two sides of the air outlet.

Compared with the prior art, the present embodiment has the following beneficial effects:

When the noise in the compressor compartment 2 of the refrigerator passes through the through hole 12 of the silencing device 1, the sound is transmitted into the silencing cavity 14 through the opening 15. This prolongs the propagation path of the sound, reduces its energy, and decreases the continuously emitted noise. As a result, the noise generated by the refrigerator is reduced, while the normal venting and heat dissipation in the compressor compartment 2 remain unaffected. This achieves a good noise reduction effect while guaranteeing the normal operation of the refrigerator.

It should be understood that although the present specification is described based on embodiments, not every embodiment contains only one independent technical solution. Such a narration way of the present specification is only for the sake of clarity. Those skilled in the art should take the present specification as an entirety. The technical solutions in the respective embodiments may be combined properly to form other embodiments which may be understood by those skilled in the art.

A series of the detailed descriptions set forth above is merely specific description of feasible embodiments of the present utility model, and is not intended to limit the protection scope of the present utility model. Equivalent embodiments or modifications made within the spirit of the present utility model shall fall within the protection scope of the present utility model.

1: A silencing device, comprising a silencing body, wherein a through hole is formed in the silencing body, the silencing body includes a hole wall enclosing the through hole, and a silencing cavity formed inside the silencing body, and an opening communicated with the silencing cavity is provided on a surface of the hole wall.

2: The silencing device according to claim 1, wherein multiple openings are arranged along the surface of the hole wall, and volumes of the silencing cavities in at least two openings are different.

3: The silencing device according to claim 1, wherein the hole wall includes a plurality of sidewalls, and each sidewall is provided with multiple openings with different areas.

4: The silencing device according to claim 3, wherein a length direction of the openings on the plurality of sidewalls is arranged along an in-out direction of the through hole, and a width direction of the openings on the plurality of sidewalls is arranged in the in-out direction of the through hole.

5: The silencing device according to claim 1, wherein the silencing cavity is provided in a labyrinth shape.

6: A refrigerator, comprising a compressor compartment, wherein the silencing device according to claim 1 is provided in the compressor compartment, and the compressor compartment is communicated with the outside through the through hole.

7: The refrigerator according to claim 6, further comprising a housing and a cavity enclosed by the housing, wherein the compressor compartment further includes a vent formed in the housing, and the through hole is provided oppositely to the vent.

8: The refrigerator according to claim 7, wherein the housing includes sidewalls arranged on two sides of the cavity, the vent includes an air inlet formed in the sidewall on one side and an air outlet formed on the other sidewall, and the silencing body abuts against the sidewall.

9: The refrigerator according to claim 8, wherein the silencing body is provided inside the cavity, the air inlet and the through hole opposite thereto have the same shape and are overlapped, and/or the air outlet and the through hole opposite thereto have the same shape and are overlapped.

10: The refrigerator according to claim 8, further comprising a fan provided in the compressor compartment, wherein an air inlet direction of the fan faces the air inlet, and an air outlet direction of the fan faces the air outlet.

11: A refrigerator, comprising a compressor compartment, wherein a fan is provided in the compressor compartment, the silencing device according to claim 1 is provided in the compressor compartment, the silencing device encloses a vent, and an air inlet and/or an air outlet of the fan are/is communicated with the vent.

12: The refrigerator according to claim 11, wherein the silencing device forms a fan bracket, and the fan is fixedly mounted in the fan bracket.

13: The refrigerator according to claim 11, wherein the fan is configured as a cross-flow fan, an air outlet of the cross-flow fan faces the outside, and the silencing device is provided at the air outlet.
